(19) United States
(12) Patent Application Publication
(10) Pub. No.: US 2004/0004441 A1
(43) Pub. Date: Jan. 8, 2004

(54) External electrode type fluorescent lamp

(76) Inventor: Hidetoshi Yano, Imabari-shi Ehime (JP)

Correspondence Address: BANNER & WITCOFF, 1001 G STREET N W, SUITE 1100, WASHINGTON, DC, 20001, US

(21) Appl. No.: 10/380,197

(22) PCT Filed: Feb. 28, 2002
(86) PCT No.: PCT/JP02/01868

(30) Foreign Application Priority Data
Mar. 1, 2001 (JP) 200156102

(51) Int. Cl. G09G 3/10

(52) U.S. Cl. 315/169.1

(57) ABSTRACT

The fluorescent lamp has a glass tube 1 on the inner surface of which a phosphor film 2 is provided. A discharge medium including at least a xenon gas is enclosed in the glass tube. An inner electrode 3 is sealed at least at one end of the glass tube 1 through which a lead terminal 4 is led out. An outer electrode 5 composed of a conductor wire 5a which is wound spirally around the outer surface of the glass tube 1 along almost the entire length. A heat shrinkage resin tube 6 coats the outer surface of the glass tube 1 including the outer electrode 5. The creeping distance along the surface of the glass tube surface between the portion where the lead terminal 4 is led out of the glass tube 1 and an end portion 5b of the conductor wire 5a composing the outer electrode 5 is selected as at least 2 mm.

### FIELD OF INVENTION

The present invention relates to a fluorescent lamp suited for backlight sources for liquid crystal display units.

### BACKGROUND TECHNOLOGY

Conventional liquid crystal display units used for electronic devices such as personal computers, liquid crystal TV sets; car navigation systems use fluorescent lamps as backlight sources. The fluorescent lamps for this backlight source are required to be provided with high performance and long life with the progress of electronic devices such as personal computers for high performance.

The fluorescent lamps utilizing rare gas such as xenon gas discharge have such merits that the brightness and the discharge voltage are hardly influenced by the ambient temperature, and have a long life. Also, the fluorescent lamps attract attention as a backlight source, because they scarcely give bad influence to the environment when being scrapped since they do not use mercury, which is a poisonous material.

An outer electrode type fluorescent lamp is known as a fluorescent lamp utilizing such rare gas discharge. This outer electrode type fluorescent lamp is composed of a glass tube on the inner wall of which a phosphor film is formed and wherein a discharge medium such as xenon gas is enclosed, an inner electrode which is sealed at least on one end of the glass tube through which a lead terminal is led out, an outer electrode composed of a conductor wire wound spirally around the outer surface of the glass tube along almost entire length of the tube at a predetermined pitch and a feed wire connected with the outer electrode.

FIGS. 1(a), (b) shows one example of a conventional known outer electrode type fluorescent lamp, wherein FIG. 1(a) is a side view and FIG. 1(b) is a side cross-section. This fluorescent lamp is provided with a glass tube 1 sealed airtight which functions as a light emitting tube as shown in FIG. 1. The inner surface of the glass tube 1 is coated with a phosphor film 2. Here, the glass tube 1 has for example, an outer diameter of about 1.2 to 10.0 mm, and a length of about 50 to 800 mm, in which rare gas, for example, xenon gas or a rare gas mixture mainly composed from xenon gas is enclosed as a discharge medium.

Also, an inner electrode 3 is provided on one side of the glass tube 1. A lead terminal 4 is connected to the inner electrode 3. One end of the lead terminal 4 is lead out of the glass tube 1 air tightly. On the outer surface of the glass tube 1, an outer electrode 5 is provided which is composed of a conductor wire 5a wound spirally along almost the entire length of the tube at the predetermined pitch. The surface of the outer electrode 5 is coated with translucent heat shrinkage type resin tube 6. The one end of the outer electrode 5 is connected by soldering or electric welding with a support lead wire 7 which is fixed on the end of the glass tube 1 opposite to the end where inner electrode 3 is provided.

Here, the inner electrode 3 is, for example, a cylindrical tube with one end open made mainly of Ni. Also, the lead terminal 4 is, for example, a wire or a rod made mainly of KOV, one end of which is connected by welding with the bottom wall of the cylindrical tube forming the inner electrode 3. The lead terminal 4 is sealed airtight within the glass tube 1 and the other end of the lead terminal 4 is lead out of the glass tube 1. Further, the outer electrode 5 is, for example, made of Ni wire. A thin wire of about 0.1 mm diameter is used so as to not to intercept the light emitted from the fluorescent lamp.

A power source 8 is connected between lead terminal 4 and the support lead wire 7. The power source 8 supplies between the inner electrode 3 and the outer electrode 5 with a high frequency square wave voltage (for example, of 1 to 5 kV voltage and of 20 to 100 KHz). A discharge is thus originated between the both electrodes 3 and 5 in the glass tube 1 thereby radiating an ultraviolet ray. The ultraviolet ray thus radiated is converted into a visible light by the phosphor film 2 on the inner wall of the glass tube 1 and which is emitted outside the glass tube 1.

The outer electrode type fluorescent lamp with such structure has a high light emitting efficiency and provides a stable light emission. Further, because the lead terminal 4 of the inner electrode 3 and the support wire 7 of the outer electrode 5 are extended from the both ends of the glass tube 1 along its axis, it is easy to be assembled in backlight units and to be connected electrically.

However, in the structure of the above mentioned outer electrode type fluorescent lamp, in which the end portion 5b of the outer electrode 5 is arranged near the lead terminal 4 of the inner electrode 3, a so-called dielectric breakdown might occur between the end portion 5b and the lead terminal 4 occurring a discharge in the air, when a high voltage pulse is applied from the power source 8. That is, a fluorescent lamp as a light source assembled in electric devices, especially in liquid crystal backlight units, is required to make a uniform discharge along the entire length of the tube which provides a uniform light emission. For this purpose, the conductor wire 5a composing the outer electrode 5 is required to be wound spirally along almost the entire length of tube. However, if the one end of the conductor wire 5a approaches too near the lead terminal 4, the discharge in the air due to the dielectric breakdown might occur.

More detailed explanation will be made on this point referring to FIG. 2. FIG. 2 is an enlarged side view showing a part of the outer electrode type fluorescent lamp shown in FIG. 1. As is shown in FIG. 2, an end portion 5b of the outer electrode 5, which is formed by winding the conductor wire 5a spirally at a predetermined pitch around the outer surface of the glass tube 1, is arranged in a position close to the portion of the glass tube 1 where the lead terminal 4 is led out. With this arrangement, a dielectric breakdown might occur on the curved surface area B of the glass tube 1 and an atmospheric discharge might occur depending on the distance A between them. Also, a leakage electric conduction might occur between the end portion of the outer electrode 5 and the portion on the glass tube 1 where the lead terminal 4 is lead out by the deposition of particles such as dust, soot, or water at the curved surface area B of the glass tube 1 according to the using condition of the fluorescent lamp.

If such atmospheric discharge or electric conduction once occurs, the impedance between the terminals of the lamp decreases and the lamp current (circuit current) suddenly increases. As the result, such accidents as the glass tube 1 composing the main body of the fluorescent lamp melts with heat, or as the inverter in the lighting circuit is damaged by heat, which is a problem in view of safety and reliability. That is, the overheating or melting of the fluorescent lamp, or heat damage of inverter cause heat damage or fire of the backlight unit using the fluorescent lamp or the electric device including the backlight unit.

Therefore, the present invention is made by taking the above background in consideration and has an object to supply a fluorescent lamp which is capable of preventing a discharge in the air or an electric conduction phenomenon and which is capable of promoting the reliability and safety of the electronic device in which the fluorescent lamps are used.

### DISCLOSURE OF THE INVENTION

The outer electrode type fluorescent lamp according to the present invention includes a glass tube on the inner surface of which a phosphor film is formed, and in which a discharge-medium including at least xenon gas is enclosed, an inner electrode which is sealed at least at one end of the glass tube through which a lead terminal is lead out, an outer electrode composed of a conductor wire which is wound spirally around the outer surface of the glass tube along almost the entire length of the glass tube, and a translucent heat shrinkage resin tube which coats the outer surface of the glass tube including the outer electrode, wherein the distance along the surface of the surface of the glass tube between the portion of the glass tube through which the lead terminal is lead out and one end of the conductor wire composing the outer electrode is selected as at least 2 mm.

In the outer electrode type fluorescent lamp according to the present invention, the glass tube has an outer diameter of 1.2 to 10.0 mm, and a length of 50 to 600 mm, and the discharge medium is a xenon gas, a mixture of xenon and neon gas, a mixture of xenon and argon gas, or a mixture of xenon and krypton gas.

Further, in the outer electrode type fluorescent lamp according to the present invention, the glass tube has an outer diameter of 1.2 to 10.0 mm, and a length of 50 to 600 mm, and the conductor wire composing the outer electrode is a non coated wire of 0.05 to 0.4 mm diameter, the end portion of which is coated with the heat shrinkage resin tube.

Further, in the outer electrode type fluorescent lamp according to the present invention, the conductor wire composing the outer electrode is an Ni wire, a Cu wire, an Al wire, a KOV wire, a Dumet wire, or a stainless steel wire.

Further, in the outer electrode type fluorescent lamp according to the present invention, the other end of the conductor wire composing the outer electrode is fixed on the support lead wire which is fixed on the other end of the glass tube, and a high frequency pulse source is connected between the support lead wire and the lead wire of the inner electrode.

Further, in the outer electrode type fluorescent lamp according to the present invention, the voltage of high frequency pulse source is from 1 to 5 kV.

Further, in the outer electrode type fluorescent lamp according to the present invention, the heat shrinkage resin tube is composed of heat shrinkage type polyethylene terephthalate resin film, polyimide resin film, or fluorocarbon resin film.

An outer electrode type fluorescent lamp according to the present invention has a glass tube on the inner surface of which a phosphor film is formed, and in which a discharge medium including at least xenon gas is enclosed, an inner electrode which is sealed in at least one end of the glass tube through which a lead terminal is led out, an outer electrode wound spirally around the outer surface of the glass tube along almost the entire length of the tube, and a translucent heat shrinkage resin tube which coats the outer surface of the glass tube including the outer electrode, wherein the conductor wire composing the outer electrode is a non coated conductor wire and the end portion of the conductor wire on the side of the lead terminal of the inner electrode is coated with an insulating film.

Further, in the outer electrode type fluorescent lamp according to the present invention, the glass tube has an outer diameter of 1.2 to 10.0 mm, and a length of 50 to 600 mm, and the discharge medium is a xenon gas, a mixed gas of xenon with neon, a mixed gas of xenon with argon, or a mixed gas of xenon with krypton.

Further, in the outer electrode type fluorescent lamp according to the present invention, the end portion of the conductor wire composing the outer electrode is coated with a silicone resin, a polyurethane resin, a vinyl resin, or an insulating film composed of metal oxide.

Further, in the outer electrode type fluorescent lamp according to the present invention, the distance along the glass tube surface between the end portion of the conductor wire which is not coated with the insulating film and the portion where the lead wire for the inner electrode is selected as at least 2 mm.

Further, in the outer electrode type fluorescent lamp according to the present invention, the glass tube has an outer diameter of 1.2 to 10.0 mm, and a length of 50 to 600 mm. The conductor wire composing the outer electrode is a non coated conductor wire having a diameter of 0.05 to 0.4 mm. The end portion of the conductor wire is coated with the heat shrinkage resin tube.

Further, in the outer electrode type fluorescent lamp according to the present invention, the conductor wire composing the outer electrode is an Ni wire, a Cu wire, an Al wire, a KOV wire, a Dumet wire, or a stainless steel wire.

Further, in the outer electrode type fluorescent lamp according to the present invention, the other end of the conductor wire composing the outer electrode is fixed on the support lead wire which is fixed on the other side of the glass tube, and a high frequency pulse source is connected between the support lead wire and the lead wire of the inner electrode.

Further, in the outer electrode type fluorescent lamp according to the present invention, the voltage of the high frequency pulse source is 1 to 5 kV.

Further, in the outer electrode type fluorescent lamp according to the present invention, the heat shrinkage resin tube is composed of a heat shrinkage type polyethylene terephthalate resin film, polyimide resin film, or fluorocarbon resin film.

### BRIEF DESCRIPTION OF THE DRAWINGS

FIG. 1 is a diagram showing an outline of a conventional outer electrode type fluorescent lamp, wherein FIG. 1(a) is a perspective side view, and FIG. 1(b) is a cross section including a lighting circuit.

FIG. 2 is a side view showing an enlarged main portion of the conventional outer electrode type fluorescent lamp.

FIG. 3 is a diagram showing an outline of an outer electrode type fluorescent lamp according to the present invention, wherein FIG. 3(a) is a side view, and FIG. 3(b) is a cross section including a lighting circuit.

FIG. 4 is an enlarged side view showing an end portion of an outer electrode type fluorescent lamp according to the first embodiment of the present invention.

FIG. 5 is a graph for explaining an effect of preventing the discharge breakdown of the outer electrode type fluorescent lamp shown in FIG. 4.

FIG. 6 is an enlarged side view showing an end portion of an outer electrode type fluorescent lamp according to the second embodiment of the present invention.

FIG. 7 is an enlarged side view showing end portion of an outer electrode type fluorescent lamp according to the third embodiment of the present invention.

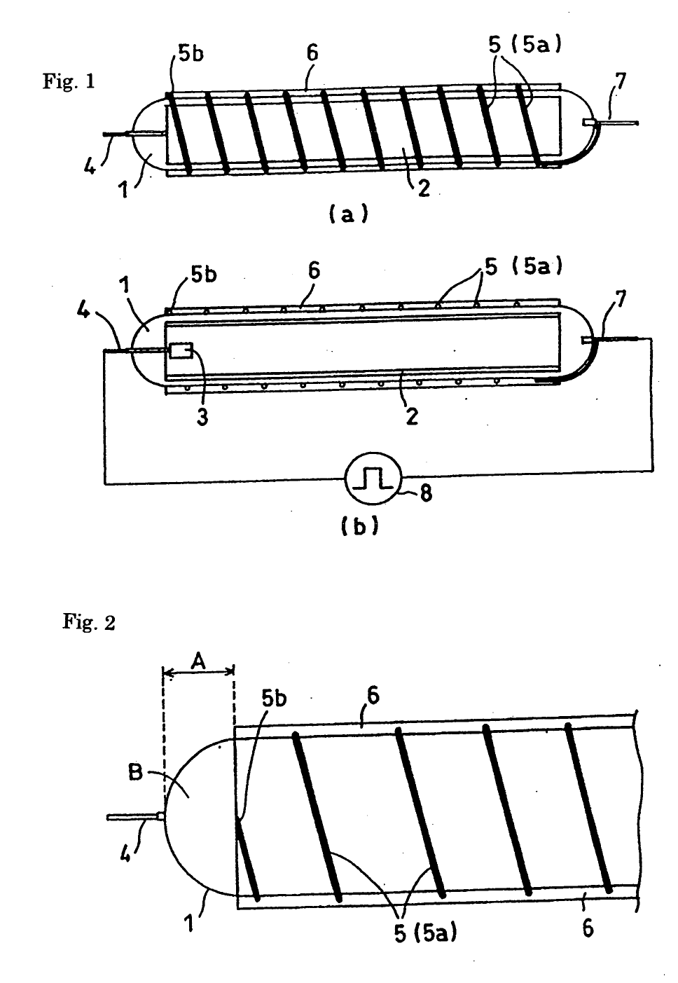

### DETAILED DESCRIPTION OF THE INVENTION

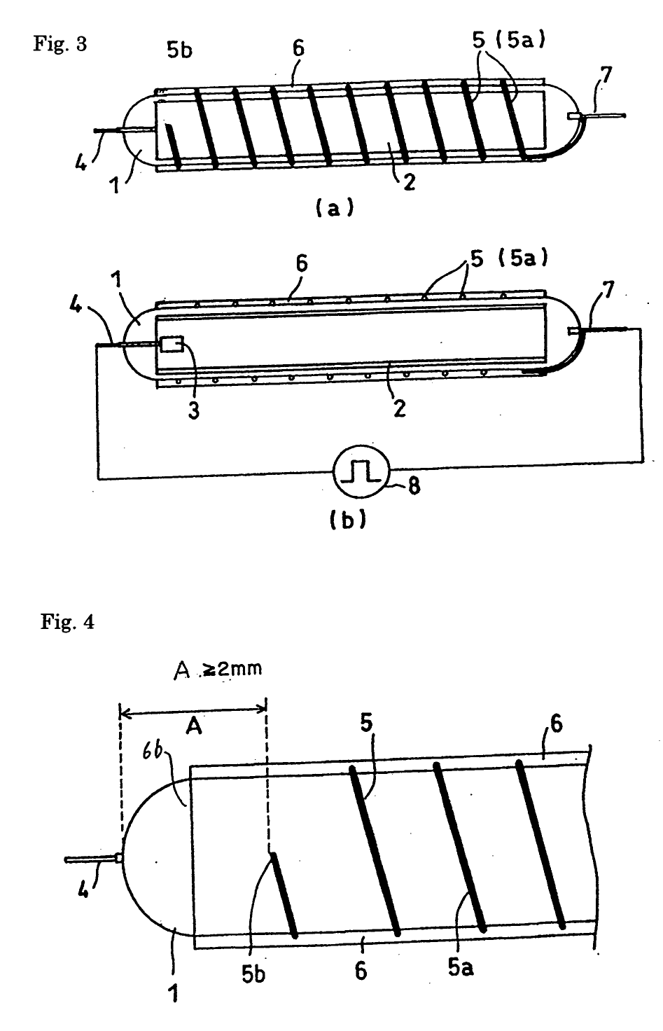

The embodiments of the present invention will be explained in detail referring to FIG. 3 to FIG. 7.

FIG. 3 shows an outline of an outer electrode type fluorescent lamp according to the present invention, wherein FIG. 3(a) is a perspective side view, and FIG. 3(b) is a cross section including a lighting circuit.

As is shown in the figure, a fluorescent lamp is provided with a sealed glass tube 1 which is sealed airtight and functions as a light emitting tube. The inner surface of the glass tube 1 is coated with a phosphor film 2. Here, the glass tube 1 has, for example, an outer diameter of about 1.2 mm to 10.0 mm, and a length of about 50 mm to 600 mm. Inside the glass tube 1, it has a rare gas as a discharge medium. The rare gas is, for example, a rare gas mainly composed of xenon gas, a mixture gas of xenon with neon, a mixture gas of xenon with argon, or a mixture gas of xenon with krypton. Further, mercury may be mixed with these rare gases acting as main components. The phosphor film 2 is composed of phosphor, which is usually used in the fluorescent lamp of this kind. The phosphor film 2 may be formed on all over the inner surface of the glass tube 1, or may be formed as an aperture structure in which the phosphor film 2 is removed with a predetermined width along the axis of the glass tube 1.

A cylindrical inner electrode 3, having an outer diameter of about 0.6 mm to 2.0 mm and a length of about 2 mm to 6 mm, for example, is provided at an end of the glass tube 1. A lead terminal 4 is connected to the inner electrode 3. One end of the lead terminal 4 is led out of the glass tube 1 with an airtight manner.

Here, the inner electrode 3 is, for example, a cylinder or a column of 2 mm to 5 mm long with one end open, composed of Ni or Ni alloy etc. (not illustrated). The inner electrode may be provided not only at one end but also at both ends of the glass tube 1. Further, the lead terminal 4 connected with the inner electrode 3 is composed of a conductor of, for example, KOV or the like. An end portion of the conductor is welded on the bottom wall of the cylinder forming the inner electrode 3. The lead terminal 4 is sealed air tightly with coaxial relation with the glass tube 1. The other end portion is lead out of the glass tube 1.

Further, an outer electrode 5 is provided on the outer surface of the glass tube 1. The outer electrode 5 is composed of a conductor wire 5a such as an Ni wire or a Cu wire having a diameter of about 0.1 mm and a resistivity of less than or equal to 2×10⁻⁴ Ω. The wire 5a is spirally wound around the outer surface of the glass tube 1 along its entire length at a constant pitch of 1 mm to 10 mm. The conductor wire is preferably a thin wire of 0.05 to 0.4 mm diameter so as not to intercept the light emitted from the fluorescent lamp. The conductor wire 5a is preferably a bare conductor wire without coating so as to make the wire as thin as possible. The shape of the cross section of the conductor wire may be any one of a circle, an ellipse, a semicircle, a rectangle, or a triangle.

Further, the pitch of the conductor wire 5a with which the conductor wire 5a is wound spirally around the outer surface of the glass tube 1 is not necessary to be constant, but it may decrease as the distance from the inner electrode 3 increases. With such configuration, the distribution of the light emission along the axis of the glass tube can be made nearly uniform.

One end of the outer electrode 5 is connected by soldering with the support lead wire 7 fixed on the opposite end of the glass tube 1 where the inner electrode 3 is provided. The support lead wire 7 is composed of, for example, an Ni wire, a Cu wire, an Al wire, a KOV wire, or a Dumet wire of 0.1 to 0.6 mm diameter. One end of the outer electrode 5 is connected electrically with the support lead wire 7 by an electric welding or a soldering.

The surface of the outer electrode 5 is coated with a tube 6 composed of a translucent heat shrinkage resin. That is, this heat shrinkage resin tube 6 not only coats the conductor wire 5a composing the outer electrode 5 insulating but also it fixes the conductor wire 5a wound at a predetermined pitch on the outer surface of the glass tube 1. Here, the heat shrinkage resin tube 6 is made of, for example, a translucent fluorocarbon resin (FEP), a polyethylene terephthalate resin, or a polyimide resin of 0.05 to 0.2 mm thick.

A power source 8 is connected between the lead terminal 4 and the support lead wire 7. The power source 8 supplies a high frequency square wave voltage (for example, of 20 to 100 KHz and of 1 to 5 kV voltage) between the inner electrode 3 and the outer electrode 5. Thus, a discharge is generated between the both electrodes 3 and 5 in the glass tube 1, emitting an ultraviolet ray. The ultraviolet ray radiated is converted into a visible light by the phosphor film 2 on the inner wall of the glass tube 1 and then emitted out of the glass tube 1.

FIG. 4 is an enlarged perspective side view showing an end portion of the outer electrode type fluorescent lamp shown in FIG. 3. As is shown in FIG. 4, the end portion 5b of the outer electrode 5 at the side of the lead terminal 4 for the inner electrode terminates at an inside portion, which is about 0.5 mm from the end portion 6b of the heat shrinkage resin tube 6. The end portion 5b is so arranged that the creeping distance A along the surface of the glass tube 1 from the portion where the terminal 4 led out is equal to or larger than 2 mm. The distance A is the distance along the curved surface of the end portion of the glass tube 1, which is the minimum distance for preventing the dielectric breakdown, that is, the least creeping distance.

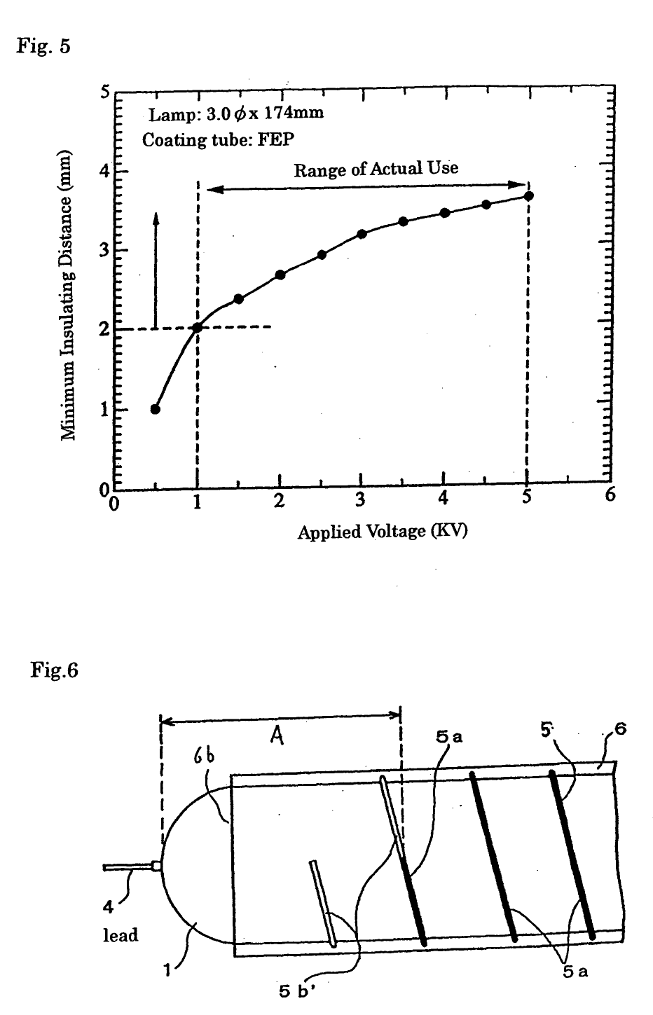

FIG. 5 is a graph for illustrating the effect of the outer electrode type fluorescent lamp shown in FIG. 4 on preventing the discharge breakdown. The abscissa of the figure indicates the pulse voltage of the high frequency power source 8 for driving the fluorescent lamp, while the ordinate indicates the least creeping distance A for insulation. Measuring the least creeping distance A in the range 1 to 5 kV of the pulse voltage of the power source 8, revealed that the least creeping distance lies in the range from 2 to 3.6 mm. The glass tube 1 of the fluorescent lamp measured had a diameter of 3.0 mm, and a length of 174 mm. However, the result of the above measurement indicated that, if the dimension of the glass tube 1 is changed, or the material of the heat shrinkage tube 6 is changed from translucent fluorocarbon resin (FEP) to polyethylene terephthalate resin, or polyimide resin, there was no essential change of the result.

In the embodiment of the present invention, since the creeping distance between the portion where lead terminal 4 is led out and the terminal portion 5b of the outer electrode which is formed and wound around the outer surface of the glass tube 1 is selected as more than 2 to 3.6 mm, the electric insulation is secured between the portions. Further, the heat shrinkage resin tube pinches the outer electrode 5 and fastens it around the outer surface of the glass tube 1 with its shrink action as well as the tube contributes to the electric insulation between the lead terminal 4 of the inner electrode 3 and the terminal portion 5b of the outer electrode 5.

Therefore, the fluorescent lamp according to the present invention, has no fear of causing atmospheric discharge or conduction between terminal portion 5b and the portion where the lead terminal 4 is led out, even when a high frequency square wave voltage is applied under the condition where the dust and moisture might deposit there between.

Therefore, in the fluorescent lamp according to the present invention, there is neither fear of sudden increase of the lamp current, nor damage caused by the rise of lamp current, nor the damage of the inverter caused by overheat, which enable to provide liquid crystal backlights and light sources for other electronic devices with high safety and reliability.

Further, according to the embodiment of the invention, the light emitting length of the glass tube 1 along the tube axis can be increased by extending the outer electrode 5 towards the end portion of the glass tube 1 where the inner electrode is provided leaving the least creeping distance.

FIG. 6 is an enlarged side view showing an end portion of the outer electrode type fluorescent lamp according to the second embodiment of the invention. The main structure of the embodiment is the same as that of the fluorescent lamp shown in FIG. 4, where the same component parts are assigned with the same symbols. Therefore, further explanation is omitted in the following and the different parts are explained.

In the embodiment, an end portion 5b′ of a conductor wire 5a forming an outer electrode 5 is coated with an insulating film. Here, the insulating film is made of, for example, a silicone resin, a polyurethane resin, a vinyl resin, or a metal oxide. The end of the end portion 5b′ coated with the insulating film terminates at the inner position from the edge 6b of the heat shrinkage resin tube 6.

With this configuration, the creeping distance A between the lead terminal 4 and the end portion of the outer electrode 5, which contributes to the atmospheric discharge, is extended to the distance between the lead terminal 4 and the end of the conductor wire 5a of the outer electrode 5 which is not coated with an insulator. Thus, there is no fear of either causing the atmospheric discharge or the leakage conduction between the terminal 5b and the portion where the lead terminal 4 is led out.

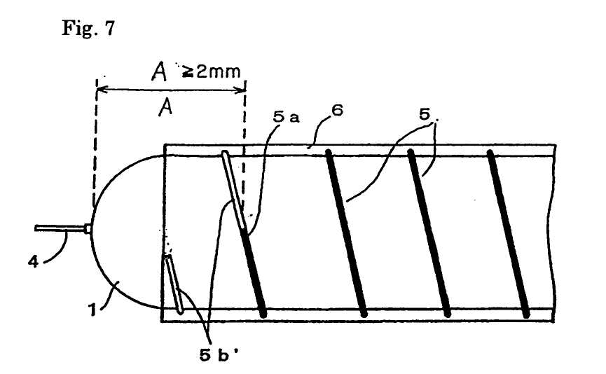

FIG. 7 is an enlarged side view showing an end portion of the outer electrode type fluorescent lamp according to the third embodiment of the present invention. Because the fundamental construction of the embodiment is same as the fluorescent lamp shown in FIG. 4 or FIG. 6, the same symbols are assigned to the same component parts and the further explanation is omitted. In the following, the different parts are explained.

In the third embodiment, an end portion 5b′ of a conductor wire 5a composing an outer electrode 5 is coated with an insulating film, which is similar to the fluorescent lamp shown in FIG. 6. However, it is different from that of FIG. 6 in that the least creeping distance A is selected as 2 mm or longer.

The present invention is not limited to the above mentioned embodiments, but can adopt many variations within the scope of the present invention. For example, the material, outer diameter, length, or shape of the glass tube etc. the material of the sealant, or the material, diameter, shape, number, or arrangement can be selected properly in accordance with the purpose to be attained.

According to the present invention described above, the electric insulation between the lead terminal of the inner electrode lead out of the glass tube and the end portion of the outer electrode is established. That is, an outer electrode type fluorescent lamp can be provided which has no fear of causing an atmospheric discharge or leakage conduction between the lead terminal of the inner electrode and the end of the outer electrode extended to the vicinity of the lead terminal. Therefore, when the fluorescent lamp is lighted, heat generation according to the sudden increase of lamp current by the decrease of lamp impedance, or heat damage of the inverter of the lighting circuit can be prevented. Thus, a liquid crystal backlight unit and other light source devices with high safety and high reliability can be obtained.

Further, with this invention, the light emitting length of the glass tube 1 along the tube axis can be made longer by extending the outer electrode 5 towards the end portion of the glass tube 1 where the inner electrode 3 is provided keeping the least creep distance.

1. An outer electrode type fluorescent lamp comprising:
a glass tube on the inside face of which a phosphor film is provided and in which a discharge medium containing at least xenon gas is enclosed,
an inner electrode which is sealed at least at one end of said glass tube through which a lead terminal is led out,
an outer electrode composed of a conductor wire which is wound spirally around an outer surface of said glass tube along almost the entire length, and
a translucent heat shrinkage resin tube which coats the outer surface of said glass tube including said outer electrode, wherein a creeping distance along said outer surface of said glass tube between the portion where said lead terminal is led out of said glass tube and an end portion of said conductor wire composing said outer electrode is sealed as at least 2 mm.

2. An outer electrode type fluorescent lamp according to claim 1, wherein said glass tube has an outer diameter ranging from 1.2 mm to 10 mm, and a length ranging from 50 to 600 mm, and wherein said discharge medium is a xenon gas, or a mixed gas of xenon with neon, a mixed gas of xenon with argon, or a mixed gas of xenon with krypton.

3. An outer electrode type fluorescent lamp according to claim 2, wherein the conductor wire composing said outer electrode is a non coated conductor wire of wire diameter ranging from 0.05 to 0.4 mm, and the end portion of said conductor wire is coated with said heat shrinkage type resin tube.

4. An outer electrode type fluorescent lamp according to claim 3, wherein the conductor wire composing said outer electrode is an Ni wire, a Cu wire, an Al wire, a KOV wire, a Dumet wire, or a stainless steel wire.

5. An outer electrode type fluorescent lamp according to claim 4, wherein the other end of the conductor wire composing said outer electrode is fixed on a support lead wire which is fixed at the other end of said glass tube, and a high frequency pulse power source is connected between said support lead wire and said lead wire of said inner electrode.

6. An outer electrode type fluorescent lamp according to claim 5, wherein a voltage of said high frequency pulse power source is ranging from 1 to 5 kV.

7. An outer electrode type fluorescent lamp according to claim 6, wherein said heat shrinkage resin tube is composed of a polyethylene terephthalate resin film, a polyimide resin film, or a fluorocarbon resin film.

8. An outer electrode type fluorescent lamp comprising:
a glass tube on the inside face of which a phosphor film is provided and in which a discharge medium containing at least xenon gas is enclosed,
an inner electrode which is sealed at least at one end of said glass tube through which a lead terminal is led out,
an outer electrode composed of a conductor wire which is wound spirally around the outer surface of said glass tube along the almost entire length, and
a translucent heat shrinkage resin tube which coats the outer surface of said glass tube including said outer electrode, wherein said conductor wire composing said outer electrode is a non coated conductor wire and an end portion of which on the side where said lead terminal used for said inner electrode is provided is coated with an insulating film.

9. An outer electrode type fluorescent lamp according to claim 8, wherein said glass tube having an outer diameter ranging from 1.2 to 10.0 mm, and a length ranging from 50 to 600 mm, and wherein said discharge medium is composed of a xenon gas, or a mixed gas of xenon with neon, a mixed gas of xenon with argon, or a mixed gas of xenon with krypton.

10. An outer electrode type fluorescent lamp according to claim 9, wherein the end portion the conductor wire composing said outer electrode is coated with an insulating film composed of a silicone resin, a polyurethane resin, or a vinyl resin, or a metal oxide.

11. An outer electrode type fluorescent lamp according to claim 10, wherein a creeping distance along said glass tube surface between an end portion of said conductor wire which composes said outer electrode and is not coated with said insulating film and a portion where said lead wire of said inner electrode is led out is selected as at least 2 mm.

12. An outer electrode type fluorescent lamp according to claim 11, wherein said glass tube has an outer diameter ranging from 1.2 to 10.0 mm, and a length ranging from 50 to 600 mm, and wherein said conductor wire composing said outer electrode is a non coated conductor wire having a wire diameter ranging from 0.05 to 0.4 mm, and an end portion of said conductor wire is coated with said heat shrinkage resin tube.

13. An outer electrode type fluorescent lamp according to claim 12, wherein the conductor wire composing said outer electrode is an Ni wire, a Cu wire, an Al wire, a KOV wire, a Dumet wire, or a stainless steel wire.

14. An outer electrode type fluorescent lamp according to claim 13, wherein the other end of the conductor wire composing said outer electrode is fixed at a support lead wire fixed on the other end of said glass tube, and a high frequency pulse power source is connected between said support lead wire and said lead wire of said inner electrode.

15. An outer electrode type fluorescent lamp according to claim 14, wherein the voltage of the high frequency pulse power source is ranging from 1 to 5 kV.

16. An outer electrode type fluorescent lamp according to claim 15, wherein said heat shrinkage resin tube is composed of a heat shrinkage polyethylene terephthalate resin film, a polyimide resin film or a fluorocarbon resin film.
